(19) United States
(12) Patent Application Publication
(10) Pub. No.: US 2005/0253312 A1
(43) Pub. Date: Nov. 17, 2005

(54) Process for manufacturing of ceramic catalytic membrane reactors by co-extrusion

(75) Inventors: Thierry Chartier, Feytiat (FR); Christophe Reynaud, Limoges (FR); Pascal Del Gallo, Dourdan (FR)

Correspondence Address: Linda K. Russell, Suite 1800, 2700 Post Oak Blvd., Houston, TX, 77056, US

(73) Assignees: L'Air Liquide, Societe Anonyme a Directoire et Conseil de Surveillance pour I'Etude et; I'Exploitation des Procedes Georges Claude

(21) Appl. No.: 11/128,047

(22) Filed: May 12, 2005

(30) Foreign Application Priority Data
May 12, 2004 (FR) 0405124

(51) Int. Cl. B28B 1/00

(52) U.S. Cl. 264/638

(57) ABSTRACT

Preparation of a supported tubular ceramic membrane composed of two coaxial layers along a axis (x), a first layer with a non-zero thickness es of a support material (S) and a second layer with a non-zero thickness e_{M} of an active material (M), characterised in that it comprises the following steps in sequence:
a step (a) to shape said supported membrane by simultaneous coaxial co-extrusion of a paste P_{S} of the support material (S) at a flow velocity along the axis (x) V_{S} and a paste P_{M} of active material (M) with a flow velocity along the axis (x) V_{M}, where V_{S}=V_{M}; a step (b) to dry the co-extrudate formed in step (a); a step (c) to debind the co-extrudate dried in step (b), and a step (d) to apply a heat treatment to co-sinter the two coaxial layers of the product obtained in step (c); Device for implementation of step (a).

The invention relates to the manufacture of catalytic membrane reactors involving electrochemical reactions in the solid state.

A Catalytic Membrane Reactor (or CMR) involves electrochemical reactions in the solid state, and shall have the following overall properties:

It shall be capable of catalysing the chemical reaction for which it was designed;

It shall have ionic, electronic or mixed conducting properties, so as to enable electrochemical transformations required by the reaction involved;

It shall be stable under the operating conditions used.

In the case of a CMR designed for reaction to reform methane into synthesis gas according to the chemical reaction:
CH₄+½O₂→2H₂+CO,
possibly involving water molecules, reaction that takes place at a temperature between 600° C. and 1100° C., preferably between 650° C. and 1000° C. The reactor is composed of at least one porous support (S) that provides the strength for the system while enabling gas transfer towards the dense membrane (M) supported on the porous support (S), of a so-called active phase in the form of a dense mixed O²⁻ anionic and electronic conducting membrane (M) and a catalytic phase (C) in the form either of a porous layer deposited on the surface of the phase (M), or catalysts in various geometric shapes such as drums or spheres, or a combination of the two.

The shaping of such a reactor causes a number of problems including cohesion and the interface between layers, the support (S), the active phase (M) and the catalyst (C). Shaping of ceramic materials by co-extrusion is one of the methods used and has already been described in the literature. There are several aspects to the concept of co-extrusion of ceramic materials. A distinction has to be made between the following co-extrusion processes:
Processes that enable the reduction of ceramic structure patterns, for example such as the process described in international application WO 02/096647 related to manufacturing of multilayer structures such as capacitors by co-extrusion of a compact stack of ceramic layers (or sheets) including thermoplastic binders;
Processes corresponding to extrusion of ceramic materials on a support, for example such as the process described in international application WO 01/53068 related to manufacturing of composites such as long fibres coated with a ceramic material obtained by extrusion of a thermoplastic ceramic paste on a fibre; and
Processes corresponding to simultaneously extrusion of several ceramic materials.

Thus, in the articles entitled “Extrusion behaviour of metal-ceramic composite pipes in multi-billet extrusion process” (J. Mater. Proc. Tech., [114], 2001, p 154-160) and “Extrusion of metal-ceramic composite pipes” (J. Am. Ceram. Soc., 83[5], 2000, p 1081-1086), Chen et al described work related to the manufacture of hollow double-layer cylindrical tubes. The layers are composed of a mix of zirconium powders and 304L stainless steel powders with relative proportions varying from 0% to 100% by volume. The cylinders are shaped by co-extrusion of aqueous pastes containing a binder consisting of a derivative of cellulose, MHPC, using a laboratory set up consisting of a multi-piston extruder mounted on a mechanical test machine. Each co-extruded layer is supplied by two pistons. The design of the equipment is such that the piston diameters are equal and the air gaps of the different layers in the die are identical. Furthermore, the piston displacement speeds transmitted by the mechanical test machine are identical. Consequently considering its design, this equipment can only be used for the production of layers with the same section, in other words as a first approximation layers that have similar thicknesses. The cylinders produced have an inside diameter of 9.6 mm, a 1.2 mm thick internal layer and a 1.0 mm thick external layer. Industrial applications targeted by the authors are applications for which the inside and the outside of a tube are subjected to different environments, which for example may be a corrosive and/or a high temperature environment inside the tube, while the environment on the outside of the tube requires ductility and resistance to thermal and mechanical shocks.

Liang and Blackburn have published an article entitled “Design and characterisation of a co-extruder to produce trilayer ceramic tubes semi-continuously” (J. Eur. Ceram. Soc., [21], 2001, p883-892), which presents a multi-piston extruder (three pistons) with dependent pistons for the production of hollow and trilayer cylindrical tubes. Unlike the set up used by Chen et al, each layer is supplied by a single piston. However, like the Chen et al. set up, this set up can only be used to produce layers with similar thicknesses. The translation speed is imposed by the mechanical test machine. Co-extrusion, in other words simultaneous extrusion of layers, requires equal extrudate velocities at the output from the die, which requires a constant ratio between the section of the air gap and the section of the piston. Therefore with this design, it is impossible to significantly vary the ratio of layer thicknesses. Cylinders produced from alumina pastes or coloured clay pastes made using this set up have an outside diameter of 6 mm, and the different layers are characterised by a non-uniform thickness of the order of 800 μm; this article does not mention any particular application.

European patent application EP 1 228 803 divulges shaping of support/catalytic membrane structures with a non-tubular cylindrical support.

None of the processes described is fully satisfactory for preparation of membrane reactors designed for preparation of synthesis gas corresponding to tubular structures composed of at least a porous material and at least a dense material with thicknesses differing by one or two orders of magnitude, and consequently the inventors attempted to develop a process that does not have the disadvantages mentioned above.

This is why the purpose of a first aspect of the invention is a process for preparation of a supported tubular ceramic membrane composed of two coaxial layers along a axis (x), a first layer with a non-zero thickness es of a support material (S) and a second layer with a non-zero thickness e_{M} of an active material (M), characterised in that it comprises the following steps in sequence:
a step (a) to shape said supported membrane by simultaneous coaxial co-extrusion of a paste P_{S} of the support material (S) at a flow velocity along the axis (x) V_{S} and a paste P_{M} of active material (M) with a flow velocity along the axis (x) V_{M}, where V_{S}=V_{M};
a step (b) to dry the co-extrudate formed in step (a);
a step (c) to debind the co-extrudate dried in step (b), and
a step (d) to apply a heat treatment to co-sinter the two coaxial layers of the product obtained in step (c),
and in that the thickness e_{M} of the layer of active material (M) is less than the thickness es of the layer of support material (S).

In the process defined above, the co-extrusion step (a is done using a device composed of three essential elements—two extruders and a co-extrusion die.

The extruders are used to apply the pressure necessary for said process to each of the pastes P_{S} and P_{M}. The extrusion pressures in the process as defined above are less than or equal to 500×10⁵ Pa (500 bars). The extruders may be either piston extruders (mechanical piston) or screw extruders.

The co-extrusion die is used to make concentric profiles composed of at least two layers. Tubes may be cylindrical or other shapes, for example elliptical tubes or tubes with multi-channel support, for example of the hollow brick type. The die is designed such that firstly the material flow for a given layer is uniform over the entire section, and secondly the material flows in the different layers are identical or similar.

In the process as defined above, the co-extrusion step (a) is usually done at a temperature between 5° C. and 200° C. It is preferably done at ambient temperature.

In the process as defined above, the drying step (b) is done by controlling evaporation of the solvent contained in the extrudate in order to prevent the appearance of cracks. It may possibly be done if necessary in a chamber with controlled temperature and humidity. The solvent may be eliminated by freeze drying including a cooling step to a very low temperature followed by a sublimation step.

The debinding step (c) is the step in the process in which organic additives are eliminated. This step is critical because it shall not induce any degradation of the structure. Several debinding methods can be used:
debinding by heat treatment under air or under a controlled atmosphere and at different pressures, and the temperature rise ramps shall be low (typically from 0.1° C./min to 1° C./min);
debinding by catalytic degradation;
debinding by extraction by supercritical fluid.

In the process as defined above, the co-sintering step (d) is a heat treatment in which ceramic skeletons are consolidated and densified.

This heat treatment operation is usually done at temperatures between 800° C. and 2100° C., preferably between 900 and 1500° C., possibly under scavenging with a controlled gas atmosphere that may be reducing or oxidising or neutral, or possibly under a vacuum.

According to a first particular aspect of the process as defined above, the thickness e_{S} of the layer of the support material (S) is greater than or equal to 500 μm and less than or equal to 10 000 μm; it is preferably between 1 000 μm and 5 000 μm

According to second particular aspect of the process as defined above, the thickness e_{M} of the layer of active material (M) is greater than or equal to 10 μm and less than or equal to 500 μm; it is preferably between 20 μm and 50 μm.

The process as defined above is particularly appropriate to the preparation of cylindrical tubes with inside diameters between 5 mm and 100 mm and more particularly between 7 mm and 50 mm.

According to a third particular aspect of the process as defined above, the layer of material (M) has a porosity ratio (P_{M}) less than 8% by volume, and more particularly less than or equal to 5% by volume.

According to a fourth particular aspect of the process as defined above, the layer of support material (S) has a porosity ratio greater than or equal to 20% by volume and less than or equal to 80% by volume, and more particularly greater than or equal to 30% by volume and less than or equal to 60% by volume.

The porosity ratio means the total porosity ratio of materials (M) and (S). The total porosity ratio is the sum of the volumes of the open porosity and the closed porosity. It is equal to the ratio of the real density and the theoretical density of the material. It can be determined by any technique for measuring three masses: the mass of dry material, mass of material impregnated by a liquid (for example water), mass of material impregnated by a liquid in the impregnation liquid, either by combining a measurement of the closed porosity ratio by helium pycnometry and a measurement of the open porosity ratio by mercury porosimetry, or by using recent mercury porosimetry equipment capable of measuring the total porosity ratio of the material (Micromeritics™ porosity meter in the AutoPore™ IV 9500 series), or by image analysis.

According to a fifth particular aspect of the process as defined above, step (a) is carried out using a set consisting essentially of a combination of:
(a)—a co-extrusion die (7) capable of producing coaxial sections with two layers along an axis x, comprising a die body (1), a front flange (6), a separator (8) capable of keeping paste flows (P_{S}) and (P_{M}) isolated from each other inside the die (7); a mandrel (2) capable of distributing the paste (P_{M}) inside the body (1) of the die (7); a punch (9) fixed to a mandrel carrier spider (4) capable of holding the paste flow (P_{S}) within it; a collar (3) that can be connected to the extruder (E_{M}) and through which the paste (P_{M}) flows towards inside the body (1) of the die (7); a collar (5) that can be connected to the extruder (E_{S}) and through which the paste (P_{S}) flows towards the inside of the body (9) of the die (7); a mandrel (10) capable of supporting the double-layer co-extrudate output from the die (7) and possibly provided with a fluid circulation device (11) capable of thermal regulation of the mandrel (10). The material flows join at the output from the separator (8).
(b)—an extruder (E_{M}) capable of extruding the paste P_{M}, comprising:
   a double-walled body (24),
   a cylindrical extension (25) capable of taking the pressure and temperature of the material circulating in said body (24),
   a mechanical system composed of a box (27), a slide (26) and a sealing ring (28) that enables either deaeration of the paste P_{M}, or pre-compression of the paste P_{M}, or extrusion of the paste P_{M}, depending on the position of said slide (26),
   a yoke (23) designed to guide a piston (29) and on which a vacuum connection is fixed,
   a fixed mechanical assembly capable of transmitting a translation movement to the piston (29) composed of a thrust box (21) supporting a hollow shaft (22) driven by a geared motor that contains a thrust screw (40) for which the rotation is blocked by a key (41) and on which a limit switch (44) is fixed,
   a rear box (42) and
   a screw casing (43);
(c)—an extruder (E_{S}) capable of extruding the paste P_{S}, comprising:
   a double-walled body (34),
   a cylindrical extension (35) capable of taking the pressure and the temperature of the material circulating in said body (34),
   a mechanical system composed of a casing (37), a slide (36) and a sealing ring (38) that enables either deaeration of the paste P_{S}, or pre-compression of the paste P_{S}, or extrusion of the paste P_{S}, depending on the position of said slide (36),
   a yoke (33) designed to guide a piston (39) and on which a vacuum connection is fixed,
   a fixed mechanical assembly capable of transmitting a translation movement to the piston (39) composed of a thrust box (31) supporting a hollow shaft (32) driven by a geared motor that contains a thrust screw (50) for which the rotation is blocked by a key (51) and on which a limit switch (54) is fixed,
   a rear box (52) and
   a screw casing (53).

In the extruder E_{M} as defined above:
said double-walled body (24) into which the active material paste P_{M} is added, is fully extractable;
a vacuum connection is fixed either to the slide (26) or onto another part for example such as the cylindrical extension (25);
the geared motor driving the hollow shaft (22) may for example be of the Lenze™ type with power 0.75 kW;
connections between the body (24) and the cylindrical extension (25) and between the yoke (23) and the body (24), are made using clamping collars (46);
the supports (45) of the clamping collars (46) and the geared motor are fixed to a sliding plate (47) positioned perpendicular to the extruder E_{S}.

In the extruder E_{S} as defined above:
said double-walled body (34), into which the active material paste P_{M} is added, is fully extractable;
a vacuum connection is fixed either to the slide (36) or onto another part for example such as the cylindrical extension (35);
the geared motor driving the hollow shaft (32) may for example be of the Lenze™ type with power 0.75 kW;
connections between the body (34) and the cylindrical extension (35), and between the yoke (33) and the body (34), are made using clamping collars (56);
the supports (55) of the clamping collars (56) and the geared motor are fixed to a frame positioned perpendicular to the extruder E_{M};
In the extrusion die (7) as defined above:
the separator (8) is fixed to the mandrel (2), the separator being screwed into the mandrel. This separator (8) performs three functions: apart from its function of separating paste flows, it also acts as a die for the support paste, and as a punch for the active material paste;
said separator (8), mandrel (2), punch (9), mandrel-carrier spider (4) and collar (5) of the die (7), are co-axial along the axis (x),
the axis (y) of said collar (3) is perpendicular to the axis (x). The material flows join together at the output from the separator (8);
the tube is shaped by a calibration device forming an integral part of the die (7). The length of this calibration device varies from a few millimetres to a few centimetres.

According to a sixth particular aspect of the invention as described above, the co-extrudate formed in step (a) is subjected to a step (a″) to cut it into unit tubular elements (Tᵢ), and more particularly into elements (Tᵢ) with identical shapes and dimensions.

According to a seventh particular aspect of the process as defined above, the process includes a preliminary step (a₀ for preparation of the paste (P_{S}).

In the process as defined above, thermoplastic aqueous pastes or formulations with organometallic precursors can be used. Aqueous formulations will be preferred that result in lower fractions by volume of organic material than are obtained with thermoplastic formulations (organic fraction by volume >30%), and consequently simplifying the debinding step (c).

When the paste (Ps) is an aqueous paste, it more particularly includes the following for a paste volume of 100%:
(i)—from 28% to 50% by volume of a powder material (S) or a mix of powder materials, to be transformed into a material (S) during one of the steps (b), (c) or (d) in the process;
(ii)—from 15% to 40% by volume of a pyrolysable pore-forming agent;
(iii)—from 0.5% to 5% by volume of at least one dispersing agent;
(iv)—from 1% to 15% by volume of at least one organic binder;
(v)—from 0% to 5% by volume of at least one plastifying agent;
(vi)—from 1% to 15% by volume of at least one lubricant; and
(vii)—from 10% to 50% by volume of a solvent.

When the paste (Ps) is a thermoplastic paste, it particularly includes the following for a paste volume of 100%:
(i)—from 28% to 50% by volume of a powder material (S) or a mix of powder materials, to be transformed into a material (S) during one of the steps (b) (c) or (d) in the process;
(ii)—from 15% to 40% by volume of a pyrolysable pore-forming agent;
(iii)—from 0.5% to 5% by volume of at least one dispersing agent;
(iv)—from 10% to 40% by volume of at least one organic binder;
(v)—from 0% to 5% by volume of at least one plastifying agent;
(vi)—from 1% to 15% by volume of at least one lubricant.

When the paste (Ps) has organometallic precursors, it particularly includes the following for a paste volume of 100%:
(i)—from 50% to 100% by volume of a mix of organometallic precursors that can be transformed into material (S) during one of the steps (b), (c) or (d) in the process;
(ii)—from 0% to 40% by volume of a pyrolysable pore-forming agent;
(iii)—from 0% to 5% by volume of at least one plastifying agent;
(iv)—from 0% to 5% by volume of at least one lubricant.

Pyrolysable pore-forming agents used in the process as defined above may in particular consist of synthetic polymer powders, for example such as polyamide powders marketed under the name Orgasol™, and poly(methylmethacrylate) (PMMA) powders, polytetrafluoroethylene (PTFE) powders, polypropylene micronised wax powders, natural polymer powders for example such as corn, wheat, potato or rice starch or sawdust or different types of ground tree bark. The powders used are characterised by a regular morphology, a relatively spherical particle shape (with a shape factor close to 1) or an elongated shape (fibre, platelet) (high shape factor). However, the chemical nature of these pyrolysable pore-forming agents shall be such that it results in a low carbonaceous residue after pyrolysis.

One particular dispersing agent that could be used in the process as defined above is PE169 phospholan™ (ethoxylated phosphoric ester) or LOMAR™ (sulfonate naphthalene).

Examples of organic binders that could be used for bridging between particles and used in the process as defined above include polymers derived from cellulose such as hydroxyethyl cellulose (HEC) or methyl celluloses, scleroglucane, xanthane or guar derivatives. This type of binder will be used in preference to thermoplastic synthetic binders (polyethylene or polypropylene . . . ).

Plastifiers for use in the process as defined above (if any) will usually be chosen to be capable of lowering the vitreous transition temperature of the binder used; in general, a polyethylene glycol with a low molecular mass (PM<1000), or a polyethylene oxide (PEO) or a phthalate for example such as dibutyl phthalate (DBP), will be used.

Examples of lubricants capable of reducing internal friction (in other words between powder particles), and external friction (in other words between the extrusion paste and the tooling) usually used in the process as defined above include fatty amines such as Rhodameenr™ CS20, glycerol, fatty acids such as oleic acid, stearic acid or mineral oils such as Vaseline oils.

Examples of the solvent used for preparation of the paste P_{S} include organic solvents such as polar solvents such as alcanols containing from 1 to 4 carbon atoms, methanol, ethanol, propanol, isopropanol, butanol, isobutanol, sec-butanol or tert-butanol or non-polar solvents such as dichloromethane, trichloromethane or tetrachloromethane. Aqueous solvents such as hydro-alcoholic solutions of methanol or ethanol can also be used; the solvent is water in one preferred embodiment of the process as described above.

According to another particular aspect of the process as defined above, the paste P_{S} does not contain a pore-forming agent. In this case, the porosity is obtained using mixes of powder of material (S) or materials that can be transformed into a material (S) or mixes of organometallic precursor powders including particles of different sizes varying from a few microns to a few tens of microns in diameter. The porosity is then obtained by stacking.

According to an eighth particular aspect of the process as defined above, the process includes a preliminarv step (a′₀) for preparation of the paste (P_{M}),

Aqueous, thermoplastic pastes or formulations with organometallic precursors can be used in the process as defined above. Aqueous formulations are preferred since they lead to lower fractions by volume of organic material than thermoplastic formulations (organic fraction by volume >30%), and consequently simplifying the debinding step (c).

When the paste (P_{M}) is an aqueous paste, it includes particularly the following for a paste volume of 100%:
(i)—from 40% to 70% by volume of a powder of active material (M) or a mix of powder materials that can be transformed into an active material (M) during one of steps (b) (c) or (d) in the process;
(ii)—from 0.5% to 8% by volume of at least one dispersing agent;
(iii)—from 1% to 15% by volume of at least one organic binder;
(iv)—from 0% to 5% by volume of at least one plastifying agent;
(v)—from 1% to 15% by volume of at least one lubricant; and
(vi)—from 15% to 50% by volume of a solvent.

When the paste (P_{M}) is a thermoplastic paste, it includes particularly the following for a paste volume of 100%:
(i)—from 40% to 70% by volume of a powder of active material (M) or a mix of powder materials that can be transformed into an active material (M) during one of steps (b), (c) or (d) in the process;
(ii)—from 0.5% to 8% by volume of at least one dispersing agent;
(iii)—from 15% to 50% by volume of at least one organic binder;
(iv)—from 0% to 5% by volume of at least one plastifying agent;
(v)—from 1% to 15% by volume of at least one lubricant.

When the paste (P_{M}) is a paste with organometallic precursors, it includes particularly the following for a paste volume of 100%:
(i)—from 90% to 100% by volume of a mix of organometallic precursors that can be transformed into an active material (M) during one of the steps (b), (c) or (d) in the process;
(ii)—from 0% to 5% by volume of at least one plastifying agent;
(iii)—from 0% to 5% by volume of at least one lubricant.

Particular dispersing agents that could be used in the process as defined above include phospholan™ PE169 (ethoxylated phosphoric ester) or LOMAR™ (sulfonate naphthalene).

Examples of organic binders capable of bridging between the particles, used in the process as defined above, include polymers derived from cellulose such as hydroxyethyl cellulose (HEC), methyl celluloses, scleroglucane, xanthane and derivatives of guar. This type of binder is preferred to the use of thermoplastic synthetic binders (polyethylene or polypropylene . . . ).

Plastifiers for use in the process as defined above will be chosen particularly among plastifiers that lower the vitreous transition temperature of the binder used; in general, a glycol polyethylene glycol with a low molecular mass (PM<1000), a polyethylene oxide (PEO) or a phthalate for example such as dibutyl phthalate (DBP) will be chosen.

Examples of lubricants capable of reducing internal friction (in other words between powder particles), and external friction (in other words between the extrusion paste and the tooling) used in the process as defined above include fatty amines such as Rhodameen™ CS20, glycerol, fatty acids such as oleic acid, stearic acid or mineral oils such as Vaseline oils.

Examples of the solvent used for preparation of the paste P_{S} include organic solvents such as polar solvents such as alcanols containing from 1 to 4 carbon atoms, methanol, ethanol, propanol, isopropanol, butanol, isobutanol, sec-butanol or tert-butanol or non-polar solvents such as dichloromethane, trichloromethane or tetrachloromethane. Aqueous solvents such as hydro-alcoholic solutions of methanol or ethanol can also be used; the solvent is water in one preferred embodiment of the process.

According to a ninth particular aspect of the process as defined above, steps (h) and (c) are performed in a single step (b′).

In the process described previously, the active material (M) used generally comprises:
from 75% by volume to 100% by volume, particularly at least 85% by volume and particularly at least 95% by volume of a dense mixed oxygen O²⁻ anionic and electronic conducting membrane (C₁) chosen from among doped ceramic oxides which at the usage temperature are in the form of a crystalline lattice with oxide ion vacancies and more particularly in the form of a cubic phase, fluorite phase, aurivillius type of perovskite phase, brown-millerite phase or pyrochloride phase, and
from 0% by volume to 25% by volume, particularly up to 10% by volume and particularly up to 5% by volume of a compound (C₂), that may or may not be different from the families of compound (C₁). If the same crystalline families as compound (C₁) are used, (C₂) is differentiated by a different chemical formulation. If the material (C₂) is different from material (C₁), (C₂) will be chosen from among oxide type ceramic materials, non-oxide type ceramic materials, metals, metal alloys or mixes of these different types of materials, and,
from 0% by volume to 2.5% by volume, particularly up to 1.5% and more particularly up to 0.5% by volume of a compound (C₃) produced from at least one chemical reaction represented by the equation:
   xF_{C1}+yF_{C2}------>zF_{C3},
in which F_{C1}, F_{C2} and F_{C3}, represent empirical formulas for compounds (C₁), (C₂) and (C₃) and x, y and z represent rational numbers >0.

According to a ninth particular aspect of the process as defined above, (C₂) is chosen either from among oxide type materials and preferably from among magnesium oxide (MgO), calcium oxide (CaO), aluminium oxide (Al₂O₃), zirconium oxide (ZrO₂), titanium oxide (TiO₂), mixed strontium and aluminium oxides SrAl₂O₄ or Sr₃Al₂O₆, mixed barium and titanium oxide (BaTiO₃) mixed calcium and titanium oxide (CaTiO₃), La_{0.5}Sr_{0.5}Fe_{0.9}Ti_{0.1}O_{3-δ} or La_{0.6}Sr_{0.4}Fe_{0.9}Ga_{0.1}O_{3-δ} or from among non-oxide type materials and preferably from among silicon carbide (SiC), boron nitride (BN), nickel (Ni), platinum (Pt), palladium (Pd) or rhodium (Rh).

According to a tenth particular aspect of the process as defined above, (C₁) is chosen from among doped ceramic oxides with formula (I):
(RₐO_{b})₁₋ₓ(R_{c}O_{d})ₓ (I),
in which:
Rₐ represents at least one trivalent or tetravalent atom chosen mainly from among bismuth (Bi), cerium (Ce), zirconium (Zr), thorium (Th), gallium (Ga) or hafnium (Hf), where a and b are such that the RₐO_{b} structure remains electrically neutral,
R_{c} represents at least one divalent or trivalent atom chosen mainly from among magnesium (Mg), calcium (Ca), barium (Ba), strontium (Sr), gadolinium (Gd), scandium (Sc), ytterbium (Yb), yttrium (Y), samarium (Sm), erbium (Er), indium (In), niobium (Nb) or lanthanum (La), where c and d are such that the R_{c}O_{d} structure is electrically neutral,
and in which x is usually between 0.05 and 0.30 and more particularly between 0.075 and 0.15.

According to this particular aspect, the material (C₁) used is chosen particularly from among stabilised zirconia with formula (Ia):
(ZrO₂)₁₋ₓ(Y₂O₃)ₓ, (Ia),
in which x is between 0.05 and 0.15.
or among stabilised cerium oxides with formula (I′a):
   (CeO₂)₁₋ₓ(Gd₂O₃)ₓ, (I′a),
in which x is between 0.05 and 0.15.

According to an eleventh particular aspect of the process as defined above, (C₁) is chosen among perovskite oxides with formula (II):
[Ma₁₋ₓ₋ᵤMa′ₓMa″ᵤ][Mb_{1-y-v}Mb′_{y}Mb″ᵥ]O_{3-w} (II)
in which,
Ma represents an atom chosen from among scandium or yttrium, or in the lanthanides, actinides or alkaline earth metal families,
Ma′ different from Ma, represents an atom chosen from among scandium, yttrium or families of lanthanides or actinides, or alkaline earth metals;
Ma″ different from Ma and from Ma′, represents an atom chosen from among aluminium (Al), gallium (Ga), indium (In), thallium (Tl) or the alkaline earth metals family;
Mb represents an atom chosen from among transition metals;
Mb′ different from Mb, represents an atom chosen from among transition metals, aluminium (Al), indium (In), gallium (Ga), germanium (Ge), antimony (Sb), bismuth (Bi), tin (Sn), lead (Pb) or titanium (Ti);
Mb″ different from Mb and from Mb′, represents an atom chosen from among transition metals, metals in the alkaline earths family, aluminium (Al), indium (In), gallium (Ga), germanium (Ge), antimony (Sb), le bismuth (Bi), tin (Sn) lead (Pb) or titanium (Ti);
0<x≦0.5;
0≦u≦0.5;
(x+u)≦0.5;
0≦y≦0.9;
0≦v≦0.9;
0≦(y+v)≦0.9
and w is such that the structure involved is electrically neutral.

According to this particular aspect, (C₁) is chosen more particularly from among compounds with formula (IIa):
La₍₁₋ₓ₋ᵤ₎Ma′ₓMa″ᵤMb_{(1y-v)}Mb′_{y}Mb″ᵥO_{3-δ} (IIa),
corresponding to formula (II), in which Ma represents a lanthanum atom, or from among compounds with formula (IIb):
   Ma₍₁₋ₓ₋ᵤ₎SrₓMa″ᵤMb_{(1-y-v)}Mb′_{y}Mb″ᵥO_{3-δ} (IIb),
corresponding to formula (II), in which Ma′ represents a strontium atom, or from among compounds with formula (IIc):
   Ma₍₁₋ₓ₋ᵤ₎Ma′ₓMa″ᵤFe_{(1-y-v)}Mb′_{y}Mb″ᵥO_{3-δ} (IIc),
corresponding to formula (II), in which Mb represents an iron atom.

The material (C₁) is then chosen more particularly from among compounds with formula (IId):
La₍₁₋ₓ₎SrₓFe₍₁₋ᵥ₎Mb″ᵥO_{3-δ} (IId),
corresponding to formula (II), in which u=0, y=0, Mb represents an iron atom, Ma a lanthanum atom and Ma′ a strontium atom,
and more particularly from among the following compounds:
   La₍₁₋ₓ₋ᵤ₎SrₓAlᵤFe₍₁₋ᵥ₎TiᵥO_{3-δ},
   La₍₁₋ₓ₋ᵤ₎SrₓAlᵤFe₍₁₋ᵥ₎GaᵥO_{3-δ},
   La₍₁₋ₓ₎SrₓFe₍₁₋ᵥ₎TiᵥO_{3-δ},
   La₍₁₋ₓ₎SrₓTi₍₁₋ᵥ₎FeᵥO_{3-δ},
   La₍₁₋ₓ₎SrₓFe₍₁₋ᵥ₎GaᵥO_{3-δ} or
   La₍₁₋ₓ₎SrₓFeO_{3-δ}

For example, the compound with formula:
La_{0.6}Sr_{0.4}Fe_{0.9}Ga_{0.1}O_{3-δ}, or
the compound with formula:
   La_{0.5}Sr_{0.5}Fe_{0.9}Ti_{0.1}O_{3-δ}.

According to this eleventh particular aspect of the process as defined above, (C₁) is also more particularly chosen from among elements with formula (II′):
Ma^{(a)}₍₁₋ₓ₋ᵤ₎Ma′^{(a-1)}ₓMa″^{(a″)}ᵤMb^{(b)}_{(1-s-y-v)}Mb^{(b+1)}ₛMb′^{(b+β)}_{y}Mb″^{(b″)}ᵥO_{3-δ} (II′),
formula (II′) in which a, a−1, a″, b, (b+1), (b+β) and b″ are integer numbers representing corresponding valences of the Ma, Ma′, Ma″, Mb, Mb′ atoms and Mb″; a, a″, b, b″, β, x, y, s, u, v and δ are such that the electrical neutrality of the crystalline lattice is conserved,
a>1,
a″, b and b″ are greater than zero;
−2≦0≦2;
a+b=6;
0<s<x;
0<x≦0.5;
0≦u≦0.5;
(x+u)≦0.5;
0≦y≦0.9;
0≦v≦0.9;
0≦(y+v+s)≦0.9
[u.(a″−a)+v.(b″−b)−x+s+βy+2δ]=0
and δₘᵢₙ<δ<δₘₐₓ where
δₘᵢₙ=[u.(a−a″)+v.(b−b″)−βy]/2 and
δₘₐₓ=[u.(a−a″)+v.(b−b″)−βy+x]/2
and Ma, Ma′, Ma″, Mb, Mb′ and Mb″ are as defined previously, Mb represents an atom chosen from among transition metals capable of existing under several possible valences;

According to a twelfth particular aspect of the process as defined above, (C₁) is chosen among oxides with formula (III):
[Mc₂₋ₓMc′ₓ][Md_{2-y}Md′_{y}]O_{6-w} (III)
in which:
Mc represents an atom chosen from among scandium, yttrium or the families of lanthanides, actinides or alkaline earth metals;
Mc′ different from Mc, represents an atom chosen from among scandium, yttrium or the families of lanthanides, actinides or alkaline earth metals;
Md represents an atom chosen from among the transition metals; and
Md′ different from Md represents an atom chosen from among transition metals, aluminium (Al), indium (In), gallium (Ga), germanium (Ge), antimony (Sb), bismuth (Bi), tin (Sn), lead (Pb) or titanium (Ti);
x and y are greater than or equal to 0 and are less than or equal to 2 and w is such that the structure involved is electrically neutral.

According to this particular aspect, (C₁) is chosen particularly from:
either compounds with formula (IIIa):
   [Mc₂₋ₓLaₓ][Md_{2-y}Fe_{y}]O_{6-w}(IIIa),
or compounds with formula (IIIb):
   [Sr₂₋ₓLaₓ][Ga_{2-y}Md′_{y}]O_{6-w} (IIIb)
(C₁) is then chosen more particularly from among compounds with formula (IIIc):
   [Sr₂₋ₓLaₓ][Ga_{2-y}Fe_{y}]O_{6-w} (IIIc),
and more particularly from among the following compounds:
   Sr_{1.4}La_{0.6}Ga_{1.2}FeO_{5.3},
   Sr_{1.6}La_{0.4}Ga_{1.2}Fe_{0.8}O_{5.3},
   Sr_{1.6}La_{0.4}GaFeO_{5.2},
   Sr_{1.6}La_{0.4}Ga_{0.8}Fe_{1.2}O_{5.2},
   Sr_{1.6}La_{0.4}Ga_{0.6}Fe_{1.4}O_{5.2},
   Sr_{1.6}La_{0.4}Ga_{0.4}Fe_{1.6}O_{5.2},
   Sr_{1.6}La_{0.4}Ga_{0.2}Fe_{1.8}O_{5.2},
   Sr_{1.6}La_{0.4}Fe₂O_{5.2},
   Sr_{1.7}La_{0.3}GaFeO_{5.15},
   Sr_{1.7}La_{0.3}Ga_{0.8}Fe_{1.2}O_{5.15},
   Sr_{1.7}La_{0.3}Ga_{0.6}Fe_{1.4}O_{5.15},
   Sr_{1.7}La_{0.3}Ga_{0.4}Fe_{1.6}O_{5.15},
   Sr_{1.7}La_{0.3}Ga_{0.2}Fe_{1.8}O_{5.15},
   Sr_{1.8}La_{0.2}GaFeO_{5.1},
   Sr_{1.8}La_{0.2}Ga_{0.4}Fe_{1.6}O_{05.1} or
   Sr_{1.8}La_{0.2}Ga_{0.2}Fe_{1.8}O_{05.1}

Another purpose of the invention is a process as defined above, in which the active material (M) used comprises 100% by volume of a dense mixed oxygen O²⁻ anionic and electronic conducting membrane (C₁).

According to a thirteenth particular aspect of the process as defined above, the support material (S) used is chosen either from among oxide type materials such as boron, aluminium, gallium, silicon, titanium, zirconium, zinc, magnesium or calcium oxides, and preferably from among magnesium oxide (MgO), calcium oxide (CaO), aluminium oxide (Al₂O₃), zirconium oxide (ZrO₂), titanium oxide (TiO₂), cerium oxide (CeO₂), mixed strontium and aluminium oxides SrAl₂O₄ or Sr₃Al₂O₆, mixed barium and titanium oxide (BaTiO₃), mixed calcium and titanium oxide (CaTiO₃), aluminium and/or magnesium silicates such as mullite (2SiO₂.3Al₂O₃) or cordierite (Mg₂Al₄Si₅O₁₈), mixed calcium and titanium oxides (CaTiO₃), calcium phosphates and their derivatives such as hydroxy—apatite [Ca₄ (CaF) (PO₄)₃] or tricalcium phosphate [Ca₃ (PO₄)₂] or perovskite type materials for example such as La_{0.5}Sr_{0.5} Fe_{0.9}Ti_{0.1}O_{3-δ} or La_{0.6} Sr_{0.4} Fe_{0.9} Ga_{0.1}O_{3-δ}La_{0.5}Sr_{0.5}Fe_{0.9}Ti_{0.1}O_{3-δ} or La_{0.6}Sr_{0.4}Fe_{0.9} Ga_{0.9}O_{3-δ} or materials with families (perovskites, brownmillerite, pyrochlorine, etc.) identical to those in the material (M) from which the dense membrane is made, or from among non-oxide type materials and preferably carbides and nitrides such as silicon carbide (SiC), boron nitride (BN) or silicon nitride (Si₃N₄), silicon and aluminium oxy-nitrides SiAlON, nickel (Ni), platinum (Pt), palladium (Pd) or rhodium (Rh).

According to a fourteenth particular aspect of the process as defined above, the support material (S) used may be of the same chemical nature as the material (M) from which the dense membrane is made,

According to a fifteenth particular aspect of the process as defined above, the support material (S) used may have the same crystalline structure as the material (M) from which the dense membrane is made.

Another purpose of the invention is an assembly consisting essentially of a combination of:
(a)—a co-extrusion die (7) capable of producing coaxial profiles with two layers along an x axis, comprising a die body (1), a front flange (6), a separator (8) capable of keeping the paste flows (P_{S}) and (P_{M}) isolated from each other inside the die (7); a mandrel (2) capable of distributing the paste (P_{M}) inside the body (1) of the die (7); a punch (9) fixed to a mandrel-carrier spider (4), capable of holding the paste flow (P_{S}) inside it; a collar (3) that can be connected to the extruder (E_{M}) and through which the paste (P_{M}) flows towards the inside of the body (1) of the die (7); a collar (5) that can be connected to the extruder (E_{S}) and through which the paste (P_{S}) flows towards the inside of the body (9) of the die (7); a mandrel (10) capable of supporting the two layer co-extrudate output from the die (7) and possibly provided with a fluid circulation device (11) capable of thermal regulation of the mandrel (10). The material flows join together at the exit from the separator (8).
(b)—an extruder (E_{M}) capable of extruding the paste P_{M}, comprising:
   a double-walled body (24),
   a cylindrical extension (25) used to take the pressure and the temperature of the material circulating in said body (24),
   a mechanical system composed of a box (27), a slide (26) and a sealing ring (28) that, depending on the position of said slide (26), is capable of deaerating the paste P_{M}, or pre-compressing the paste P_{M}, or extruding the paste P_{M},
   a yoke (23) capable of guiding a piston (29) and on which a vacuum connection is fitted,
   a fixed mechanical assembly capable of transmitting a translation movement to the piston (29) composed of a thrust box (21) supporting a hollow shaft (22) driven by a geared motor, that contains a thrust screw (40) for which the rotation is prevented by a key (41) and on which a limit switch (44) is fixed,
   a rear box (42) and
   a screw casing (43);
(c)—an extruder (E_{S}) capable of extruding the paste P_{S}, comprising:
   a double-walled body (34),
   a cylindrical extension (35) used to take the pressure and the temperature of the material circulating in said body (34),
   a mechanical system composed of a box (37), a slide (36) and a sealing ring (38) that, depending on the position of said slide (36), is capable of deaerating the paste P_{S}, or pre-compressing the paste P_{S}, or extruding the paste P_{S},
   a yoke (33) capable of guiding a piston (39) and on which a vacuum connection is fitted,
   a fixed mechanical assembly capable of transmitting a translation movement to the piston (39) composed of a thrust box (31) supporting a hollow shaft (32) entrained by a geared motor, that contains a thrust screw (50) for which rotation is blocked by a key (51) and on which a limit switch (54) is fixed,
   a rear box (52) and
   a screw casing (53).

In the extruder E_{M} as defined above:
said double-walled body (24), into which the active material paste P_{M} is added, is fully extractable;
a vacuum connection is fixed either to the slide (26) or onto another part for example such as the cylindrical extension (25);
the geared motor driving the hollow shaft (22) may for example be of the Lenze™ type with power 0.75 kW;
connections between the body (24) and the cylindrical extension (25) and between the yoke (23) and the body (24), are made using clamping collars (46);
the supports (45) of the clamping collars (46) and the geared motor are fixed to a sliding plate (47) positioned perpendicular to the extruder E_{S}.

In the extruder E_{S} as defined above:
said double-walled body (34), into which the active material paste P_{M} is added, is fully extractable;
a vacuum connection is fixed either to the slide (36) or onto another part for example such as the cylindrical extension (35);
the geared motor driving the hollow shaft (32) may for example be of the Lenze™ type with power 0.75 kW;
connections between the body (34) and the cylindrical extension (35), and between the yoke (33) and the body (34), are made using clamping collars (56);
the supports (55) of the clamping collars (56) and the geared motor are fixed to a flame positioned perpendicular to the extruder E_{M};

In the extrusion die (7) as defined above:
the separator (8) is fixed to the mandrel (2), the separator being screwed into the mandrel. This separator (8) performs three functions: apart from its function of separating paste flows, it also acts as a die for the support paste, and as a punch for the active material paste;
said separator (8), mandrel (2), punch (9), mandrel-carrier spider (4) and collar (5) of the die (7), are co-axial along the axis (x),
the axis (y) of said collar (3) is perpendicular to the axis (x). The material flows join together at the output from the separator (8);
the tube is shaped by a calibration device forming an integral part of the die (7). The length of this calibration device varies from a few millimetres to a few centimetres.

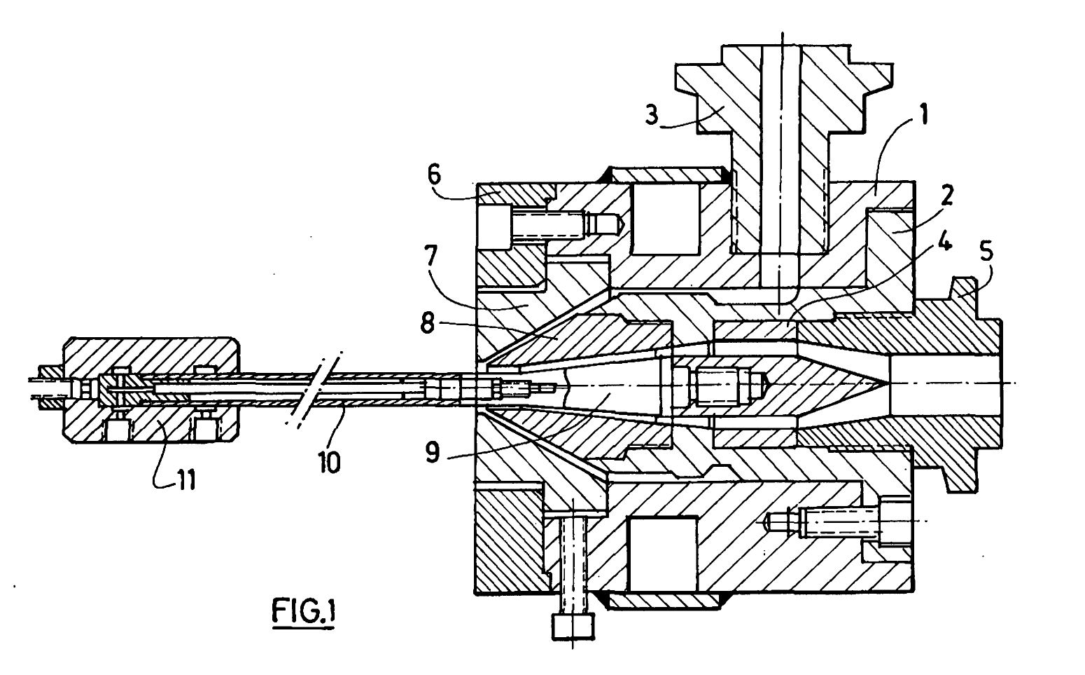

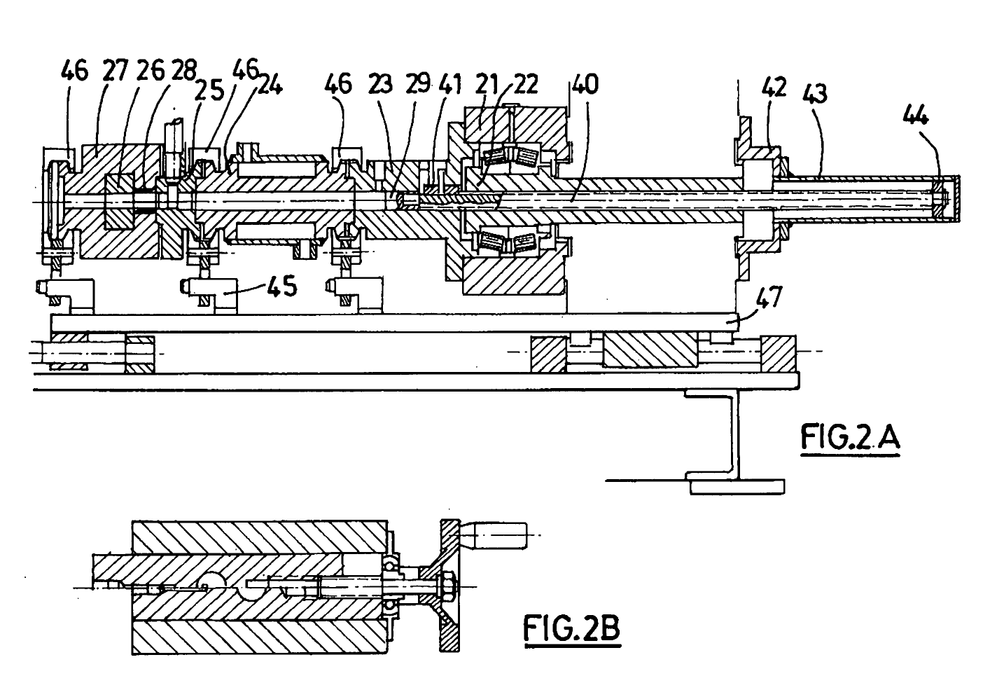

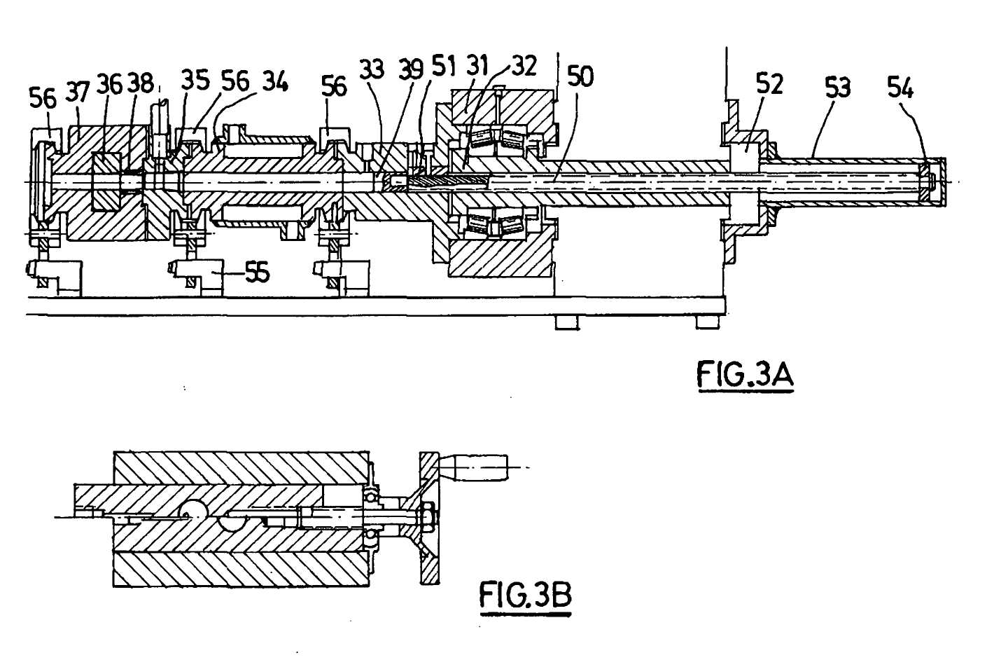

This type of device is illustrated in FIGS. 1 to 3 that represent the die (7), the extruder E_{S} and the extruder E_{M} respectively.

According to another aspect, the purpose of the invention is a process for preparation of a membrane catalytic reactor, characterised in that it comprises a step to apply a reforming catalyst on the outside face of the material (M) of the tubular ceramic membrane supported directly obtained by the process as defined above.

This type of reactor can then be used for the reaction to reform methane into a synthesis gas according to the following chemical reaction:
CH₄+ 1/2O₂→2H₂+CO,
possibly with the addition of water molecules, a reaction that takes place at a temperature between 600° C. and 1100° C. Preferably between 650° C. and 1000° C.

In the context of this use, there is no need to apply a reforming catalyst when the support S itself has catalytic properties, particularly when it is doped with noble metals such as platinum, palladium or rhodium or with transition metals such as nickel or iron.

Finally, the co-extrusion process according to this patent application may also be used for any system composed of a ceramic porous support and a ceramic dense membrane for production and/or separation of gases. Note the use of this technique to prepare Ceramic Oxygen Generators (COG) or Solid Oxide Fuel Cells, or ceramic membranes for the separation and/or production of hydrogen in gas mixes containing hydrogen.

The following examples illustrate the invention but do not limit it.

### EXAMPLE 1

A paste (Ps) and a paste (P_{M}) composed of the same material are prepared.

Composition of the Support Paste (P_{S}):

| | | Composition of the |
|---|---|---|
| | | support paste (Pₛ) |
| | | (% by volume) |
| Ceramic powder | La_{0.5}Sr_{0.5}Fe_{0.9}Ti_{0.1}O_{3-δ} | 36.00 |
| | (0.5 < d₅₀ < 1 μm) | |
| Pore-forming | PMMA Acrylone 4510 | 24.00 |
| agent | | |
| Dispersing agent | Phospholan PE169 | 3.27 |
| Binder | Natrosol 250HHR | 3.81 |
| Lubricant 1 | Rhodameen CS20 | 2.69 |
| Lubricant 2 | Glycerol | 3.77 |
| Solvent | Demineralised water | 26.46 |

Composition of the Membrane Paste (P_{M}):

| | | Composition of the |
|---|---|---|
| | | membrane paste (P_{M}) |
| | | (% by volume) |
| Ceramic powder | La_{0.5}Sr_{0.5}Fe_{0.9}Ti_{0.1}O_{3-δ} | 48.00 |
| | (0.5 < d₅₀ < 1 μm) | |
| Dispersing agent | Phospholan PE169 | 5.01 |
| Binder | Natrosol 250MR | 4.87 |
| Lubricant 1 | Rhodameen CS20 | 3.44 |
| Lubricant 2 | Glycerol | 4.83 |
| Solvent | Demineralised water | 33.85 |

Extrusion conditions: extrudate speed: 5 cm/min
Drying—debinding—sintering in air cycle:
   drying at ambient temperature 20° C.,
   debinding in air, gradient 24° C./h from T_{amb} to 600° C., constant for 1 h at 600° C.,
   sintering in air, gradient 300° C./h up to 1250° C., constant for 2 h at 1250° C.

### EXAMPLE 2

A paste (Ps) and a paste (P_{M}) composed of two different materials are prepared.

Composition of the Support Paste (P_{S}):

| | | Composition of the |
|---|---|---|
| | | support paste (Pₛ) |
| | | (% by volume) |
| Ceramic powder | La_{0.5}Sr_{0.5}Fe_{0.9}Ti_{0.1}O_{3-δ} | 36.00 |
| | (0.5 < d₅₀ < 1 μm) | |
| Pore-forming | PMMA Acrylone 4510 | 24.00 |
| agent | | |
| Dispersing agent | Phospholan PE169 | 3.27 |
| Binder | Natrosol 250HHR | 3.81 |
| Lubricant 1 | Rhodameen CS20 | 2.69 |
| Lubricant 2 | Glycerol | 3.77 |
| Solvent | Demineralised water | 26.46 |

Composition of the Membrane Paste (P_{M}):

| | | Composition of the |
|---|---|---|
| | | membrane paste (P_{M}) |
| | | (% by volume) |
| Ceramic powder | La_{0.6}Sr_{0.4}Fe_{0.9}Ga_{0.1}O_{3-δ} | 45.00 |
| | (0.5 < d₅₀ < 1 μm) | |
| Dispersing agent | Phospholan PE169 | 4.70 |
| Binder | Natrosol 250MR | 5.22 |
| Lubricant 1 | Rhodameen CS20 | 3.68 |
| Lubricant 2 | Glycerol | 5.17 |
| Solvent | Demineralised water | 36.24 |

Extrusion conditions: extrudate speed: 5 cm/min
Drying—debinding—sintering in air cycle:
   drying at ambient temperature 20° C.,
   debinding in air, gradient 24° C./h from T_{amb} to 600° C., constant for 1 h at 600° C.,
   sintering in air, gradient 300° C./h up to 1250° C., constant for 2 h at 1250° C.

1-22. (canceled)

23. A process for preparation of a supported tubular ceramic membrane composed of two coaxial layers along a axis (x), a first layer with a non-zero thickness e_{S} of a support material (S) and a second layer with a non-zero thickness e_{M} of an active material (M), wherein said process comprises the following steps in sequence:
a step (a) to shape said supported membrane by simultaneous coaxial co-extrusion of a paste P_{S} of the support material (S) at a flow velocity along the axis (x) V_{S} and a paste P_{M} of active material (M) with a flow velocity along the axis (x) V_{M}, where V_{S}=V_{M};
a step (b) to dry the co-extrudate formed in step (a);
a step (c) to debind the co-extrudate dried in step (b), and
a step (d) to apply a heat treatment to co-sinter the two coaxial layers of the product obtained in step (c),
and in that the thickness e_{M} of the layer of active material (M) is less than the thickness es of the layer of support material (S).

24. The process of claim 23, in which step (a) carried out using a set consisting essentially of a combination of:
(a) a co-extrusion die (7) capable of producing coaxial sections with two layers along an axis x, comprising a die body (1), a front flange (6), a separator (8) capable of keeping paste flows (P_{S}) and (P_{M}) isolated from each other inside the die (7); a mandrel (2) capable of distributing the paste (P_{M}) inside the body (1) of the die (7); a punch (9) fixed to a mandrel carrier spider (4) capable of holding the paste flow (P_{S}) within it; a collar (3) that can be connected to the extruder (E_{M}) and through which the paste (P_{M}) flows towards inside the body (1) of the die (7); a collar (5) that can be connected to the extruder (E_{S}) and through which the paste (P_{S}) flows towards the inside of the body (9) of the die (7); a mandrel (10) capable of supporting the double-layer co-extrudate output from the die (7) and possibly provided with a fluid circulation device (11) capable of thermal regulation of the mandrel (10);
(b) an extruder (E_{M}) capable of extruding the paste P_{M}, comprising:
a double-walled body (24);
a cylindrical extension (25) capable of taking the pressure and temperature of the material circulating in said body (24);
a mechanical system composed of a box (27), a slide (26) and a sealing ring (28) that enables either deaeration of the paste P_{M}, or pre-compression of the paste P_{M}, or extrusion of the paste P_{M}, depending on the position of said slide (26);
a yoke (23) designed to guide a piston (29) and on which a vacuum connection is fitted;
a fixed mechanical assembly capable of transmitting a translation movement to the piston (29) composed of a thrust box (21) supporting a hollow shaft (22) driven by a geared motor that contains a thrust screw (40) for which the rotation is blocked by a key (41) and on which a limit switch (44) is fixed,
a rear box (42); and
a screw casing (43); and
(c) an extruder (E_{S}) capable of extruding the paste P_{S}, comprising:
a double-walled body (34);
a cylindrical extension (35) capable of taking the pressure and the temperature of the material circulating in said body (34);
a mechanical system composed of a casing (37), a slide (36) and a sealing ring (38) that enables either deaeration of the paste P_{S}, or pre-compression of the paste P_{S}, or extrusion of the paste P_{S}, depending on the position of said slide (36);
a yoke (33) designed to guide a piston (39) and on which a vacuum connection is fixed;
fixed mechanical assembly capable of transmitting a translation movement to the piston (39) composed of a thrust box (31) supporting a hollow shaft (32) driven by a geared motor that contains a thrust screw (50) for which the rotation is blocked by a key (51) and on which a limit switch (54) is fixed;
rear box (52); and
screw casing (53).

25. The process of claim 23, in which the co-extrudate formed in step (a) is subjected to a step (a″) to cut it into unit tubular elements (Tᵢ), and more particularly into elements (Tᵢ) with identical shapes and dimensions.

26. The process of claim 23, including a preliminary step (a₀) for preparation of the paste (P_{S}).

27. The process of claim 23, in which the paste (Ps) is chosen from:
either an aqueous paste including the following for a paste volume of 100%:
(i) from 28% to 50% by volume of a powder material (S) or a mix of powder materials, to be transformed into a material (S) during one of the steps (b), (c) or (d) in the process;
(ii) from 15% to 40% by volume of a pyrolysable pore-forming agent;
(iii) from 0.5% to 5% by volume of at least one dispersing agent;
(iv) from 1% to 15% by volume of at least one organic binder;
(v) from 0% to 5% by volume of at least one plastifying agent;
(vi) from 1% to 15% by volume of at least one lubricant; and
(vii) from 10% to 50% by volume of water;
or a thermoplastic paste including the following for a paste volume of 100%:
(i) from 28% to 50% by volume of a powder material (S) or a mix of powder materials, to be transformed into a material (S) during one of the steps (b), (c) or (d) in the process;
(ii) from 15% to 40% by volume of a pyrolysable pore-forming agent;
(iii) from 0.5% to 5% by volume of at least one dispersing agent;
(iv) from 10% to 40% by volume of at least one organic binder;
(v) from 0% to 5% by volume of at least one plastifying agent;
(vi) from 1% to 15% by volume of at least one lubricant;
or a paste with organometallic precursors including the following for a paste volume of 100%:
(i) from 50% to 100% by volume of a mix of organometallic precursors that can be transformed into material (S) during one of the steps (b), (c) or (d) in the process;
(ii) from 0% to 40% by volume of a pyrolysable pore-forming agent;
(iii) from 0% to 5% by volume of at least one plastifying agent;
(iv) from 0% to 5% by volume of at least one lubricant.

28. The process of claim 23, including a preliminary step (a′₀) for preparation of the paste (P_{M}).

29. The process of claim 23, in which the paste (P_{M}) is chosen from:
either an aqueous paste, including particularly the following for a paste volume of 100%:
(i) from 40% to 70% by volume of a powder of active material (M) or a mix of powder materials that can be transformed into an active material (M) during one of steps (b), (c) or (d) in the process;
(ii) from 0.5% to 8% by volume of at least one dispersing agent;
(iii) from 1% to 15% by volume of at least one organic binder;
(iv) from 0% to 5% by volume of at least one plastifying agent;
(v) from 1% to 15% by volume of at least one lubricant; and
(vi) from 15% to 50% by volume of water;
or a thermoplastic paste including particularly the following for a paste volume of 100%:
(i) from 40% to 70% by volume of a powder of active material (M) or a mix of powder materials that can be transformed into an active material (M) during one of steps (b), (c) or (d) in the process;
(ii) from 0.5% to 8% by volume of at least one dispersing agent;
(iii) from 15% to 50% by volume of at least one organic binder;
(iv) from 0% to 5% by volume of at least one plastifying agent;
(v) from 1% to 15% by volume of at least one lubricant.
or a paste with organometallic precursors including the following for a paste volume of 100%:
(i) from 90% to 100% by volume of a mix of organometallic precursors that can be transformed into an active material (M) during one of the steps (b), (c) or (d) in the process;
(ii) from 0% to 5% by volume of at least one plastifying agent;
(iii) from 0% to 5% by volume of at least one lubricant

30. The process of claim 23, in which steps (b) and (c) are performed in a single step (b′).

31. The process of claim 23, in which the active material (M) used comprises:
from 75% by volume to 100% by volume, particularly at least 85% by volume and particularly at least 95% by volume of a dense mixed oxygen O²⁻ anionic and electronic conducting membrane (C₁) chosen from among doped ceramic oxides which at the usage temperature are in the form of a crystalline lattice with oxide ion vacancies and more particularly in the form of a cubic phase, fluorite phase, aurivillius type of perovskite phase, brown—millerite phase or pyrochloride phase, and
from 0% by volume to 25% by volume, particularly up to 10% by volume and particularly up to 5% by volume of a compound (C₂), that may or may not be different from compound (C₁), chosen from among oxide type ceramic materials, non-oxide type ceramic materials, metals, metal alloys or mixes of these different types of materials, and,
from 0% by volume to 2.5% by volume, particularly up to 1.5% and more particularly up to 0.5% by volume of a compound (C₃) produced from at least one chemical reaction represented by the equation:
xF_{C1}+yF_{C2}------>zF_{C3},
in which F_{C1}, F_{C2} and F_{C3}, represent empirical formulas for compounds (C₁), (C₂) and (C₃) and x, y and z represent rational numbers >0.

32. The process of claim 31, in which (C₂) is chosen, either from among oxide type materials and preferably from among magnesium oxide (MgO), calcium oxide (CaO), aluminium oxide (Al₂O₃), zirconium oxide (ZrO₂), titanium oxide (TiO₂), mixed strontium and aluminium oxides SrAl₂O₄ or Sr₃Al₂O₆, mixed barium and titanium oxide (BaTiO₃) mixed calcium and titanium oxide (CaTiO₃), La_{0.5}Sr_{0.5}Fe_{0.9}Ti_{0.1}O_{3-δ} or La_{0.6}Sr_{0.4}Fe_{0.9}Ga_{0.1}O_{3-δ} or from among non-oxide type materials and preferably from among silicon carbide (SiC), boron nitride (BN), nickel (Ni), platinum (Pt), palladium (Pd) or rhodium (Rh).

33. The process of claim 31, in which (C₁) is chosen from among doped ceramic oxides with formula (I):
(RₐO_{b})₁₋ₓ(R_{c}O_{d})ₓ (I),
in which:
Rₐ represents at least one trivalent or tetravalent atom chosen mainly from among bismuth (Bi), cerium (Ce), zirconium (Zr), thorium (Th), gallium (Ga) or hafnium (Hf), where a and b are such that the RₐO_{b} structure remains electrically neutral; and
R_{c} represents at least one divalent or trivalent atom chosen mainly from among magnesium (Mg), calcium (Ca), barium (Ba), strontium (Sr), gadolinium (Gd), scandium (Sc), ytterbium (Yb), yttrium (Y), samarium (Sm), erbium (Er), indium (In), niobium (Nb) or lanthanum (La), where c and d are such that the R_{c}O_{d} structure is electrically neutral; and
and in which x is usually between 0.05 and 0.30 and more particularly between 0.075 and 0.15.

34. The process of claim 33, in which the material (C₁) used is chosen particularly from among stabilised zirconia with formula (Ia):
(ZrO₂)₁₋ₓ(Y₂O₃)ₓ, (Ia),
in which x is between 0.05 and 0.15,
or among stabilised cerium oxides with formula (I′a):
(CeO₂)₁₋ₓ(Gd₂O₃)ₓ, (I′a),
in which x is between 0.05 and 0.15.

35. The process of claim 31, in which (C₁) is chosen among perovskite oxides with formula (II):
[Ma₁₋ₓ₋ᵤMa′ₓMa″ᵤ][Mb_{1-y-v}Mb′_{y}Mb″ᵥ]O_{3-w} (II)
in which,
Ma represents an atom chosen from among scandium, yttrium or in the lanthanides, actinides or alkaline earth metal families;
Ma′ different from Ma, represents an atom chosen from among scandium, yttrium or families of lanthanides or actinides, or alkaline earth metals;
Ma″ different from Ma and from Ma′, represents an atom chosen from among aluminium (Al), gallium (Ga), indium (In), thallium (Tl) or the alkaline earth metals family;
Mb represents an atom chosen from among transition metals;
Mb′ different from Mb, represents an atom chosen from among transition metals, aluminium (Al), indium (In), gallium (Ga), germanium (Ge), antimony (Sb), bismuth (Bi), tin (Sn), lead (Pb) or titanium (Ti);
Mb″ different from Mb and from Mb′, represents an atom chosen from among transition metals, metals in the alkaline earth family, aluminium (Al), indium (In), gallium (Ga), germanium (Ge), antimony (Sb), bismuth (Bi), tin (Sn) lead (Pb) or titanium (Ti);
0<x≦0.5;
0≦u≦0.5;
(x+u)≦0.5;
0≦y≦0.9;
0≦v≦0.9; and
0≦(y+v)≦0.9;
and w is such that the structure involved is electrically neutral.

36. The process of claim 35, in which (C₁) is chosen from among compounds with formula (IIa):
La₍₁₋ₓ₋ᵤ₎Ma′ₓMa″ᵤMb_{(1y-v)}Mb′_{y}Mb″ᵥO_{3-δ} (IIa),
corresponding to formula (II), in which Ma represents a lanthanum atom; or from among compounds with formula (IIb):
Ma₍₁₋ₓ₋ᵤ₎SrₓMa″ᵤMb_{(1-y-v)}Mb′_{y}Mb″ᵥO_{3-δ (IIb),}
corresponding to formula (II), in which Ma′ represents a strontium atom; or from among compounds with formula (IIc):
Ma₍₁₋ₓ₋ᵤ₎Ma′ₓMa″ᵤFe_{(1-y-v)}Mb′_{y}Mb″ᵥO_{3-δ} (IIc),
corresponding to formula (II), in which Mb represents an iron atom.

37. The process of claim 36, in which (C₁) is chosen from among compounds with formula (IId):
La₍₁₋ₓ₎SrₓFe₍₁₋ᵥ₎Mb″ᵥO_{3-δ} (IId),
corresponding to formula (II), in which u=0, y=0, Mb represents an iron atom, Ma a lanthanum atom and Ma′ a strontium atom,
particularly from among the following compounds:
La₍₁₋ₓ₋ᵤ₎SrₓAlᵤFe₍₁₋ᵥ₎TiᵥO_{3-δ},
La₍₁₋ₓ₋ᵤ₎SrₓAlᵤFe₍₁₋ᵥ₎GaᵥO_{3-δ},
La₍₁₋ₓ₎SrₓFe₍₁₋ᵥ₎TiᵥO_{3-δ},
La₍₁₋ₓ₎SrₓTi₍₁₋ᵥ₎FeᵥO_{3-δ},
La₍₁₋ₓ₎SrₓFe₍₁₋ᵥ₎GaᵥO_{3-δ} or
La₍₁₋ₓ₎SrₓFeO_{3-δ}
For example, the compound with formula:
La_{0.6}Sr_{0.4}Fe_{0.9}Ga_{0.1}O_{3-δ}, or
the compound with formula:
La_{0.5}Sr_{0.5}Fe_{0.9}Ti_{0.1}O_{1-δ}.

38. The process of claim 35, in which (C₁) is chosen from among elements with formula (II′):
Ma^{(a)}₍₁₋ₓ₋ᵤ₎Ma′^{(a-1)}ₓMa″^{(a″)}ᵤMb^{(b)}_{(1-s-y-v)}Mb^{(b+1)}ₛMb′^{(b+β)}_{y}Mb″^{(b″)}ᵥO_{3-δ} (II′),
formula (II′) in which: a, a−1, a″, b, (b+1), (b+β) and b″ are integer numbers representing corresponding valences of the Ma, Ma′, Ma″, Mb, Mb′ atoms and Mb″; a, a″, b, b″, β, x, y, s, u, v and δ are such that the electrical neutrality of the crystalline lattice is conserved,
a>1,
a″, b and b″ are greater than zero;
−2≦β≦2;
a+b=6;
0<s<x;
0<x≦0.5;
0≦u≦0.5;
(x+u)≦0.5;
0≦y≦0.9;
0≦v≦0.9;
0≦(y+v+s)≦0.9
[u.(a″−a)+v.(b″−b)−x+s+βy+2δ]=0
and δₘᵢₙ<δ<δₘₐₓ, where
δₘᵢₙ=[u.(a−a″)+v.(b−b″)−βy]/2 and
δₘₐₓ=[u.(a−a″)+v.(b−b″)−βy+x]/2
and Ma, Ma′, Ma″, Mb, Mb′ and Mb″ are as defined previously, Mb represents an atom chosen from among transition metals capable of existing under several possible valences.

39. The process of claim 31, in which (C₁) is chosen among oxides with formula (III):
[Mc₂₋ₓMc′ₓ][Md_{2-y}Md′_{y}]O_{6-w} (III)
in which:
Mc represents an atom chosen from among scandium, yttrium or the families of lanthanides, actinides or alkaline earth metals;
Mc′ different from Mc, represents an atom chosen from among scandium, yttrium or the families of lanthanides, actinides or alkaline earth metals;
Md represents an atom chosen from among the transition metals; and
Md′ different from Md represents an atom chosen from among transition metals, aluminium (Al), indium (In), gallium (Ga), germanium (Ge), antimony (Sb), bismuth (Bi), tin (Sn), lead (Pb) or titanium (Ti);
x and y are greater than or equal to 0 and are less than or equal to 2 and w is such that the structure involved is electrically neutral; and is particularly chosen from:
either compounds with formula (IIIa):
[Mc₂₋ₓLaₓ][Md_{2-y}Fe_{y}]O_{6-w} (IIIa),
or compounds with formula (IIIb):
[Sr₂₋ₓLaₓ][Ga_{2-y}Md′_{y}]O_{-w} (IIIb).

40. The process of claim 31, in which the active material (M) used comprises 100% by volume of a dense mixed oxygen O²⁻ anionic and electronic conducting membrane (C₁).

41. The process of claim 31, in which the support material (S) used is chosen:
either from among oxide type materials such as boron, aluminium, gallium, silicon, titanium, zirconium, zinc, magnesium or calcium oxides, and preferably from among magnesium oxide (MgO), calcium oxide (CaO), aluminium oxide (Al₂O₃), zirconium oxide (ZrO₂), titanium oxide (TiO₂), cerium oxide (CeO₂), mixed strontium and aluminium oxides SrAl₂O₄ or Sr₃Al₂O₆, mixed barium and titanium oxide (BaTiO₃), mixed calcium and titanium oxide (CaTiO₃), aluminium and/or magnesium silicates such as mullite (2SiO₂.3Al₂O₃) or cordierite (Mg₂Al₄Si₅O₁₈), mixed calcium and titanium oxides (CaTiO₃), calcium phosphates and their derivatives such as hydroxy—apatite [Ca₄ (CaF) (PO₄)₃] or tricalcium phosphate [Ca₃ (PO₄)₂] or perovskite type materials for example such as La_{0.5}Sr_{0.5}Fe_{0.9}Ti_{0.1}, O_{3-δ} or La_{0.6}Sr_{0.4}Fe_{0.9}Ga_{0.1}, O₃La_{0.5}Sr_{0.5}Fe_{0.9}Ti_{0.1}, O_{3-δ} or La_{0.6}Sr_{0.4}Fe_{0.9}Ga_{0.1}O_{3-δ} or materials with families (perovskites, brownmillerite, pyrochlorine, etc.) identical to those in the material (M) from which the dense membrane is made;
or from among non-oxide type materials and preferably carbides and nitrides such as silicon carbide (SiC), boron nitride (BN) or silicon nitride (Si₃N₄), silicon and aluminium oxy-nitrides SiAlON, nickel (Ni), platinum (Pt), palladium (Pd) or rhodium (Rh).

42. A device for implementation of step (a) in the process of claim 23, consisting essentially of a combination of:
(a) a co-extrusion die (7) capable of producing coaxial profiles with two layers along an x axis, comprising a die body (1), a front flange (6), a separator (8) capable of keeping the paste flows (P_{S}) and (P_{M}) isolated from each other inside the die (7); a mandrel (2) capable of distributing the paste (P_{M}) inside the body (1) of the die (7); a punch (9) fixed to a mandrel-carrier spider (4), capable of holding the paste flow (P_{S}) inside it; a collar (3) that can be connected to the extruder (E_{M}) and through which the paste (P_{M}) flows towards the inside of the body (1) of the die (7); a collar (5) that can be connected to the extruder (E_{S}) and through which the paste (P_{S}) flows towards the inside of the body (9) of the die (7); a mandrel (10) capable of supporting the two layer co-extrudate output from the die (7) and possibly provided with a fluid circulation device (11) capable of thermal regulation of the mandrel (10);
(b) an extruder (E_{M}) capable of extruding the paste P_{M}, comprising:
a double-walled body (24),
a cylindrical extension (25) used to take the pressure and the temperature of the material circulating in said body (24),
a mechanical system composed of a box (27), a slide (26) and a sealing ring (28) that, depending on the position of said slide (26), is capable of deaerating the paste P_{M}, or pre-compressing the paste P_{M}, or extruding the paste P_{M},
a yoke (23) capable of guiding a piston (29) and on which a vacuum connection is fitted,
a fixed mechanical assembly capable of transmitting a translation movement to the piston (29) composed of a thrust box (21) supporting a hollow shaft (22) driven by a geared motor, that contains a thrust screw (40) for which the rotation is prevented by a key (41) and on which a limit switch (44) is fixed,
a rear box (42) and
a screw casing (43);
(c) an extruder (E_{S}) capable of extruding the paste P_{S}, comprising:
a double-walled body (34);
a cylindrical extension (35) used to take the pressure and the temperature of the material circulating in said body (34);
a mechanical system composed of a box (37), a slide (36), and a sealing ring (38) that, depending on the position of said slide (36), is capable of deaerating the paste P_{S}, or pre-compressing the paste P_{S}, or extruding the paste P_{S};
a yoke (33) capable of guiding a piston (39) and on which a vacuum connection is fitted;
a fixed mechanical assembly capable of transmitting a translation movement to the piston (39) composed of a thrust box (31) supporting a hollow shaft (32) entrained by a geared motor, that contains a thrust screw (50) for which rotation is blocked by a key (51) and on which a limit switch (54) is fixed;
a rear box (52); and
a screw casing (53).
